(19) United States
(12) Patent Application Publication
(10) Pub. No.: US 2024/0401775 A1
(43) Pub. Date: Dec. 5, 2024

(54) Dual-Output Laser-Driven Light Source

(71) Applicants: HAMAMATSU PHOTONICS K.K., Shizuoka (JP); ENERGETIQ TECHNOLOGY, INC., Wilmington, MA (US)

(72) Inventors: Qingsong Wang, Lexington, MA (US); Huiling Zhu, Lexington, MA (US)

(73) Assignees: HAMAMATSU PHOTONICS K.K., Shizuoka (JP); ENERGETIQ TECHNOLOGY, INC., Wilmington, MA (US)

(21) Appl. No.: 18/329,505

(22) Filed: Jun. 5, 2023

(51) Int. Cl. F21V 7/04; F21K 9/61; F21V 9/20

(52) U.S. Cl. CPC F21V 7/041; F21K 9/61; F21V 9/20

(57) ABSTRACT

A dual-output light source includes a laser-driven light source that generates light from a thermal plasma over an angular range of emission of at least 180 degrees. A first and second off-axis conical mirror are positioned within the at least 180 degrees of emission of the thermal plasma so that light generated by the plasma propagating from a first region of emission strikes a first focal point of the first off-axis conical mirror and light generated by the plasma propagating from a second region of emission strikes a first focal point of the second off-axis conical mirror. The first and second off-axis conical mirrors reflect light in a respective and first and second optical paths. A first optical filter having a first bandwidth is positioned in the first optical path. A second optical filter having a second bandwidth is positioned in the second optical path.

The section headings used herein are for organizational purposes only and should not be construed as limiting the subject matter described in the present application in any way.

### INTRODUCTION

Numerous commercial and academic applications have a need for broad band high brightness light in the 170 nm to 2.1 micron spectrum range. For example, broad-band high-brightness light is needed for numerous industrial applications, including photolithography, metrology, accelerated life testing, photoresist development and testing, defect inspection, and microscopy. Other applications for broad-band high brightness light include spectroscopy, aerial imaging, and blank mask inspection. These and other applications require broad-band high-brightness light sources that have high reliability, small physical size, low fixed cost, low operating cost, flexible operating space to optimize the operation to the desired application and low complexity. Known broad-band high-brightness light sources have limited performance and usefulness because of various engineering difficulties. Also, known broad-band high-brightness light sources are typically single output light sources with limited functionality.

### SUMMARY

A dual-output light source includes a laser-driven light source that generates light from a thermal plasma over an angular range of emission of at least 180 degrees. A first and second off-axis conical mirror are positioned within the at least 180 degrees of emission of the thermal plasma so that light generated by the plasma propagating from a first region of emission strikes a first focal point of the first off-axis conical mirror and light generated by the plasma propagating from a second region of emission strikes a first focal point of the second off-axis conical mirror. The first and second off-axis conical mirrors reflect light in a respective first and second optical path. The first and second off-axis conical mirrors can include optical filters with different filter functions. A first optical filter with a first filter function is positioned in the first optical path so that light is passed with a first optical spectrum to a first output that is positioned at a second focal point of the first off-axis conical mirror. Similarly, a second optical filter is positioned in the second optical path so that light is passed with a second optical spectrum to a second output that is positioned at a second focal point of the second off-axis conical mirror.

A method of generating light according to the present teaching includes producing a thermal plasma that generates light over an angular range of emission of at least 180 degrees. The generated light is propagated to a first focal point of a first mirror so that it reflects the generated light in a first optical path and is propagated to a first focal point of a second mirror so that it reflects the generated light in a first optical path. Light in the first optical path is filtered to form a first output optical beam with a first optical spectrum. Light in the second optical path is filtered to form a second output optical beam with a second optical spectrum. The first output optical beam is propagated to a first output at a second focal point of the first mirror. The second output optical beam is propagated to a second output at a second focal point of the second mirror.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings described below are for illustration purposes only. The drawings are not necessarily to scale; emphasis is instead generally being placed upon illustrating principles of the teaching. The drawings are not intended to limit the scope of the Applicant's teaching in any way.

FIG. 1A illustrates a side-view of an embodiment of a dual-output light source optical system configured according to the present teaching that includes a pair of off-axis conical mirrors that couple flux from the plasma to two separate output channels.

FIG. 1B illustrates a top-view of the embodiment of the dual-output light source optical system described in connection with FIG. 1A that is configured according to the present teaching to include a first and second off-axis conical mirror that couple flux from the laser-driven light source to two separate output channels.

FIG. 1C illustrates a perspective-view of the embodiment of the dual-output light source optical system described in connection with FIG. 1A that is configured according to the present teaching to include a first and second off-axis conical mirror that couple flux from a laser-driven light source to two separate output channels.

FIG. 2 illustrates a side-view of an embodiment of a dual-output light source optical system configured according to the present teaching that includes a pair of off-axis conical mirrors that couple flux from the plasma to two separate output channels that are combined into a single optical fiber channel.

FIG. 3 illustrates a side-view of an embodiment of a dual-output light source optical system configured according to the present teaching that includes a pair of off-axis conical mirrors that couple flux from the plasma to two separate output channels that are combined into a single free space optical channel.

FIG. 4 illustrates data for percentage of reflectance as a function of wavelength in microns for various reflective materials that are suitable for use as a reflective surface for the first and second off-axis conical mirrors in some embodiments of the dual-output light source optical system of the present teaching.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications, and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

The present teaching relates to broad-band light that can operate at relatively high brightness. The term “broad-band” light as used herein refers to light having a wavelength in the 170 nm to 2.1 micron spectrum range. That is, the term “broad-band” light refers to light in the deep ultraviolet to the infrared region of the electromagnetic spectrum. It is technically difficult to generate high-brightness light over this large range of the electromagnetic spectrum. It is particularly difficult to generate light with different spectral characteristics at multiple outputs over this large range of the electromagnetic spectrum.

Broad-band high-brightness light sources are used in numerous state-of-the art optical measurement and exposure applications. It is desirable that these broad-band high-brightness light sources be configured to accommodate numerous use cases, some of which require dual or multiple outputs that provide light with different optical properties. Currently, broad-band high-brightness light sources with such multiple outputs and high performance are not available in the market. It should be understood that many aspects of the present teaching are described in connection with a dual output light sources. However, it is understood that the present teachings can be extended to a plurality of outputs including three or more outputs that is useful for many applications requiring outputs with different spectral properties and/or that use parallel operation.

Plasmas can be used to generate a wide spectral range of photons. For example, plasmas generated according to the present teaching can generate light from the deep ultraviolet spectrum to the infrared spectrum. The methods and apparatus of the present teachings relate to plasma generated light sources.

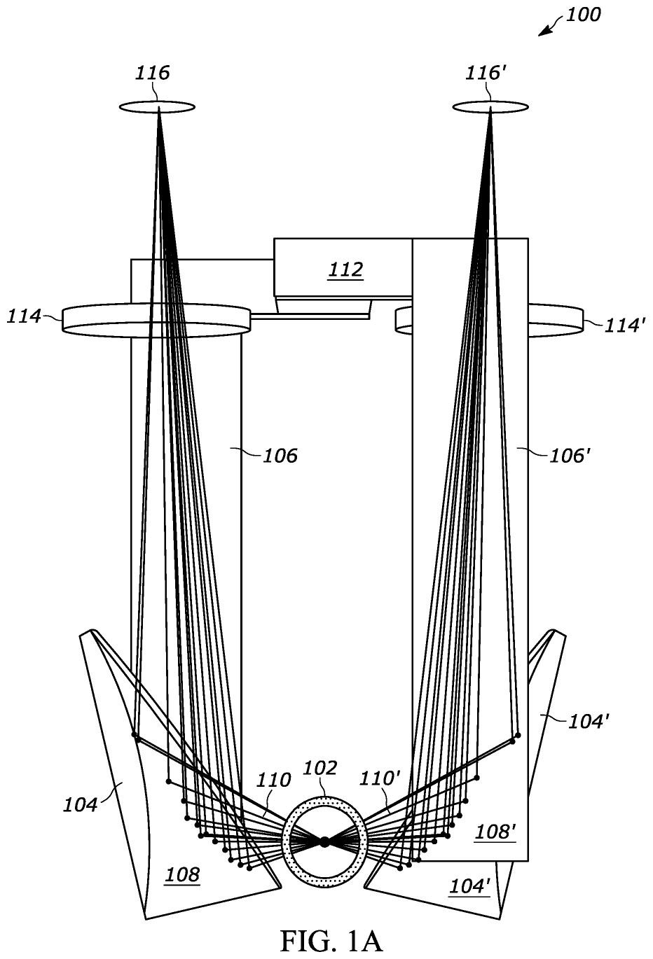

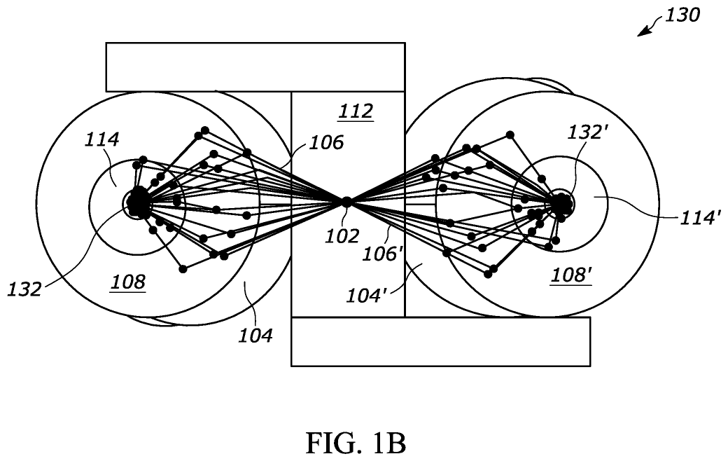

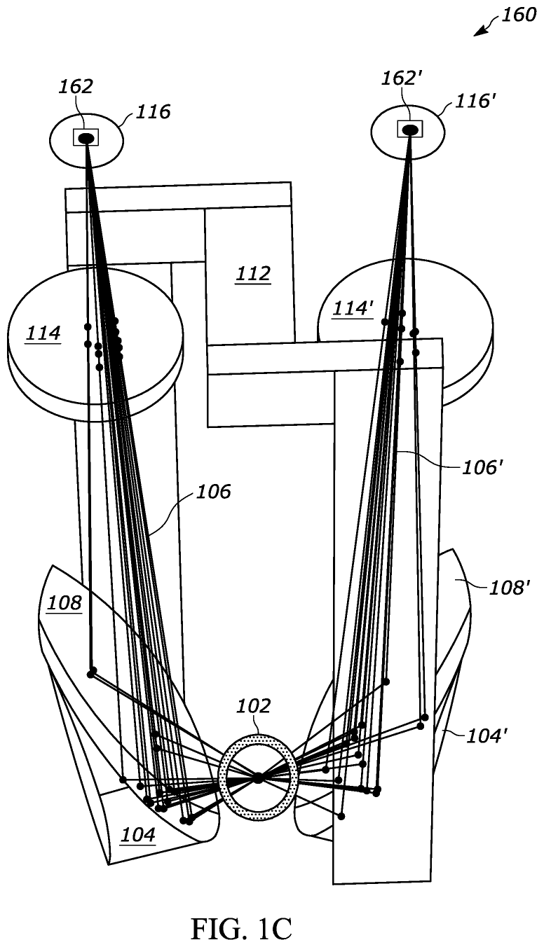

FIG. 1A illustrates a side-view of an embodiment of a dual-output light source system 100 configured according to the present teaching. In one embodiment, the light source system 100 includes a laser-driven light source 102 that generates broad-band light from a thermal plasma formed in the center of a bulb or chamber, were the bulb or chamber has some regions that are substantially transparent to electromagnetic radiation having desired wavelengths to allow light to pass through the chamber or bulb. In various embodiments, the laser-driven light source 102 comprises a broad-band light source that emits ultraviolet, visible light, and/or near-infrared light.

Light is emitted from the plasma at the center of the bulb in all directions. The bulb or chamber is transparent to electromagnetic radiation having desired wavelengths over an angular range of emission of at least 180 degrees. See, for example, U.S. Pat. No. 11,587,781, entitled “Laser-Driven Light Source with Electrodeless Ignition”, which is assigned to the present assignee, for an example of a state-of-the-art laser-driven light source. Such electrodeless light sources are available from Energetiq, a Hamamatsu Company, located in Wilmington, MA. These light sources are based on a Z-pinch plasma and they avoid electrodes entirely by inductively coupling current into the plasma. The plasma in these light sources is magnetically confined away from the source walls, minimizing the heat load and reducing debris and providing excellent open-loop spatial stability, and stable repeatable power output. Such light sources are highly desirable for applications requiring high brightness with a compact physical footprint.

The light source system 100 also includes first and second off-axis conical mirrors 104, 104′ that couple light flux from the plasma light source 102 into a first and a second separate optical output channel 106, 106′. The first and the second separate optical output channel 106, 106′ may be referred to as a first and a second optical path 106. 106′. In some embodiments of light sources according to the present teaching, at least one of the first and second off-axis conical mirrors 104, 104′ are movable so that a perpendicular to the surface of the first off-axis conical mirror moves relative to output apertures at outputs 116, 116′ of the light source. Also, in one embodiment of the light source, at least one of the first and second off-axis conical mirrors 104, 104′ is an off-axis ellipsoidal mirror. In another embodiment of the light source, at least one of the first and second off-axis conical mirrors 104, 104′ is an off-axis-parabolic mirror.

The first off-axis conical mirror 104 includes a reflective surface 108 that is positioned proximate to a first region of emission 110 of the laser-driven light source 102 so that light generated by the thermal plasma and propagating from the first region of emission 110 of the laser-driven light source 102 strikes a first focal point of the first off-axis conical mirror 104 and is then reflected away in a first optical path 106, where the dots show ray tracing.

Similarly, the second off-axis conical mirror 104′ includes a reflective surface 108′ that is positioned proximate to a second region of emission 110′ of the laser-driven light source 102 that is within the at least 180-degree angular range of emission. Light from the second region of emission 110′ is reflected by the reflective surface 108′ into a second optical path 106′, where the dots show ray tracing. The generated light propagating from the second region of emission 110′ of the laser-driven light source 102 strikes a first focal point of the second off-axis conical mirror 104′. In many embodiments, the reflective surfaces comprise a material that is highly reflective over the spectral regions of interest. For example, gold and aluminum coatings can be used.

At least one of the reflective surface 108 on the first off-axis conical mirror 104 that is positioned proximate to the first region of emission 110 of the laser-driven light source 102 and the reflective surface 108′ on the second off-axis conical mirror 104′ that is positioned proximate to a second region of emission 110′ includes an optical coating other than a reflective mirror coating. For example, at least one of these surfaces 108, 108′ can include an optical coating that forms an optical filter. Such optical filters can have the same optical filter function for each surface 108, 108′, or the optical filters can have an optical filter for one surface 108 and a different optical filter function for the other surface 108′. The filter functions can be, for example, a bandpass filter function or a high or low pass filter function. In many embodiments of the light source 100 of the present teaching, both the surface 108 on the first off-axis conical mirror 104 that is positioned proximate to the first region of emission 110 of the laser-driven light source 102 and the surface 108′ on the second off-axis conical mirror 104′ that is positioned proximate to a second region of emission 110′ include a coating that forms an optical filter so that the first off-axis conical mirror 104 comprises a filter with a first optical bandwidth and the second off-axis conical mirror 104′ comprises a filter with second optical bandwidth, where the first and second optical bandwidth are not equal and do not have the same center wavelength.

For example, in one particular embodiment of the light source of the present teaching, the first off-axis conical mirror 104 includes an optical coating configured as an optical filter with a bandwidth in the ultraviolet region of the electromagnetic spectrum and the second off-axis conical mirror 104′ is configured with an optical coating with a bandwidth in the visible region of the electromagnetic spectrum. In another particular embodiment, the first off-axis conical mirror 104 includes an optical coating configured as an optical filter with a bandwidth in the ultraviolet region of the electromagnetic spectrum and the second off-axis conical mirror 104′ is configured with an optical coating with a bandwidth in the near-infrared region of the electromagnetic spectrum. In yet another particular embodiment, the first off-axis conical mirror 104 includes an optical coating configured as an optical filter with a bandwidth in the near-infrared region of the electromagnetic spectrum and the second off-axis conical mirror 104′ is configured with an optical coating with a bandwidth in the visible region of the electromagnetic spectrum. In another particular embodiment, the first off-axis conical mirror 104 and the second off-axis conical mirror 104′ both include optical coatings configured as optical filters with the same bandwidth. In yet another specific embodiment, a first optical filter 114 and a second optical filter 114′ are configured to filter substantially the same bandwidth of the electromagnetic spectrum.

A first optical filter 114 is positioned in the first optical path 106. The first optical filter 114 comprises a first filter function that passes light with a first optical spectrum to a first output 116 that is positioned at a second focal point of the first off-axis conical mirror 104. Similarly, a second optical filter 114′ is positioned in the second optical path 106′. The second optical filter 114′ comprises a second filter function that passes light with a second optical spectrum to a second output 116′ that is positioned at a second focal point of the second off-axis conical mirror 104′. In one practical configuration, a mechanical frame 112 supports the first and second optical filters 114, 114′. The first and second optical filters 114, 114′ can be separate, stand-alone filters that can have filter functions that are different or the same as the filter functions of any optical filters configured on the first off-axis conical mirror 104 and configured on the second off-axis conical mirror 104′.

The first and second optical outputs 116, 116′ can be configured in various ways that are suitable for the particular application of the dual-output light source 100. In some embodiments, the first optical output 116 is configured with a first numerical aperture and the second optical output 116′ is configured with a second numerical aperture that is different from the first numerical aperture so that the dual-output light source 100 can couple generated light into two different systems with different optical input configurations.

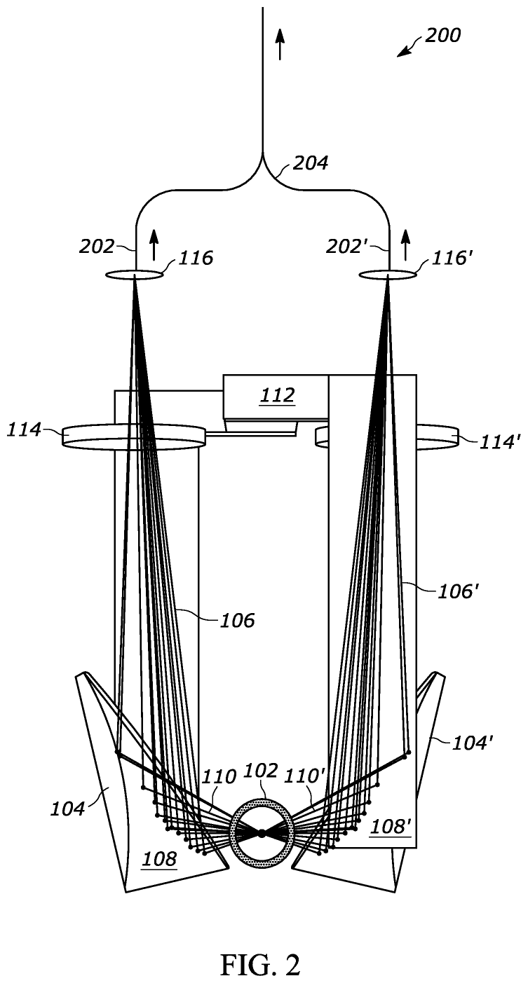

Also, in various embodiments according to the present teaching, one or two optical fibers can be coupled to one or both of the first and second outputs 116, 116′ so that EUV light generated by the light source system 100 is propagated in the one or two optical fibers as described more in connection with FIG. 2. Possible configurations of the outputs 116, 116′ according to the present teaching can include any combination of free space and optical fibers.

FIG. 1B illustrates a top-view of the embodiment of the dual-output light source optical system 130 described in connection with FIG. 1A that is configured according to the present teaching to include a first and second off-axis conical mirror 104, 104′ that couple flux from the laser-driven light source 102 to two separate output channels 106, 106′. As described in connection with FIG. 1A, the light source optical system 100 shows the mechanical frame 112 that support the first and second optical filters 114, 114′. The first and second off-axis conical mirror 104, 104′ are positioned under the first and second optical filters 114, 114′ in respective ones of the first and second optical paths 106, 106′. The reflective surfaces 108, 108′ are shown directly under the first and second optical filters 114, 114′. The group of dots in the center of the first and second optical filters 114, 114′ are generated from ray tracing and are positioned at respective second focal points 132, 132′ of the first and second off-axis conical mirrors 104, 104′.

FIG. 1C illustrates a perspective-view of the embodiment of the dual-output light source optical system 160 described in connection with FIG. 1A that is configured according to the present teaching to include a first and second off-axis conical mirror 104, 104′ that couple flux from a laser-driven light source 102 to two separate output channels 106, 106′. The perspective-view shown in FIG. 1C is similar to the side-view that is described in detail in connection with FIG. 1A. However, the perspective-view shows more detailed ray tracing illustrating the first and second focal points of the first and second off-axis conical mirror 104, 104′.

As described in connection with FIG. 1A, the light source optical system 160 shows the mechanical frame 112 that supports the first and second optical filters 114, 114′. The laser-driven light source 102 is positioned proximate to the first and second off-axis conical mirror 104, 104′ so as to couple light flux from the plasma light source 102 into the first and second optical output channel 106, 106′. The dots in the ray tracing on the first and second off-axis conical mirror 104, 104′ indicate where the rays strike the first focal points of the conical mirror 104, 104′ on the reflective surfaces 108, 108′. Similarly, the dots in the ray tracing on the first and second optical filters 114, 114′ indicate where the rays strike the optical filters 114, 114′ in transmission to the second focal points of the conical mirror 104, 104′. The outputs 116, 116′ show the rays striking the second of two focal points 162, 162′ formed by the conical mirror 104, 104′.

FIG. 2 illustrates a side-view of an embodiment of a high-brightness broad-band dual-output light source optical system 200 configured according to the present teaching that includes a pair of off-axis conical mirrors 104, 104′ that couple flux from the plasma to two separate output channels 106, 106′ that are combined into a single optical fiber channel. The dual-output broad-band light source optical system 200 is similar to the dual-output broad-band light source optical system 100 that is described in connection with FIGS. 1A-C but also includes output fiber coupling and fiber combining that combines optical beams with different spectral properties.

More specifically, the light source system 200 includes first and second off-axis conical mirrors 104, 104′ that couple light flux from the plasma light source 102 into a first and a second separate optical output channel 106, 106′. At least one of the first and second off-axis conical mirrors 104, 104′ can be movable. At least one of the first and second off-axis conical mirrors 104, 104′ can be an off-axis ellipsoidal mirror or an off-axis-parabolic mirror. The first and second off-axis conical mirrors 104, 104′ each include a reflective surface 108, 108′ that is positioned proximate to respective ones of the first and second regions of emission 110, 110′ that are within the at least 180-degree angular range of emission so that light generated by the thermal plasma and propagating from these regions of emission strikes respective ones of the first focal point of the first and second off-axis conical mirrors 104, 104′ and is then reflected away in respective ones of the first and second optical paths 106, 106′. Like in FIG. 1A-1C, the dots show ray tracing of rays reflecting off the reflective surfaces 108, 108′.

At least one of the reflective surfaces 108, 108′ on respective ones of the first and second off-axis conical mirrors 104, 104′ that is positioned proximate to respective ones of the first and second regions of emission 110, 110 of the laser-driven light source 102 includes an optical coating that forms an optical filter. The filter function of one or both of these optical filters can be, for example, a bandpass filter function or a high or low pass filter function. In many embodiments of the light source of the present teaching, both the surface on the first off-axis conical mirror 104 and the surface on the second off-axis conical mirror 104′ include a coating that forms an optical filter so that the first off-axis conical mirror 104 comprises a filter with a first optical bandwidth and the second off-axis conical mirror 104′ comprises a filter with second optical bandwidth, where the first and second optical bandwidth are not equal.

The first optical filter 114 that passes light with a first optical spectrum is positioned in the first optical path 106. Similarly, the second optical filter 114′ that passes light with a second optical spectrum is positioned in the second optical path 106′. The mechanical frame 112 supports the first and second optical filters 114, 114′.

The first and second optical outputs 116, 116′ are positioned at respective ones of the second focal points of the first and second off-axis conical mirror 104, 104′. In the fiber coupled configuration shown in FIG. 2, the first optical output 116 is coupled to a first optical fiber 202 and the second optical output 116′ is coupled to a second optical fiber 202′. An optical fiber combiner 204 includes a first input that is coupled to the first optical fiber 202 and a second input that that is coupled to the second optical fiber 202′.

An output of the optical fiber combiner 204 passes a combined optical beam that includes the optical spectra of optical beams in the first and second optical paths 106, 106′. The combined optical spectra include a first optical beam that has been filtered by any filters on the surface of the first off-axis conical mirrors 104 and then filtered by the first optical filters 114. Also, the combined optical spectra include a second optical beam that has been filtered by any filters on the surface of the second off-axis conical mirrors 104′ and then filtered by the second optical filters 114′. In many embodiments, the filter functions of filters formed on the surface of the first and second off-axis conical mirrors 104, 104′ and or filter functions of the first and second optical filters 114, 114′ are different so that beams of two different optical spectra are combined in the optical combiner 204 to generate a combined optical spectrum with a more complex spectrum for a desired application.

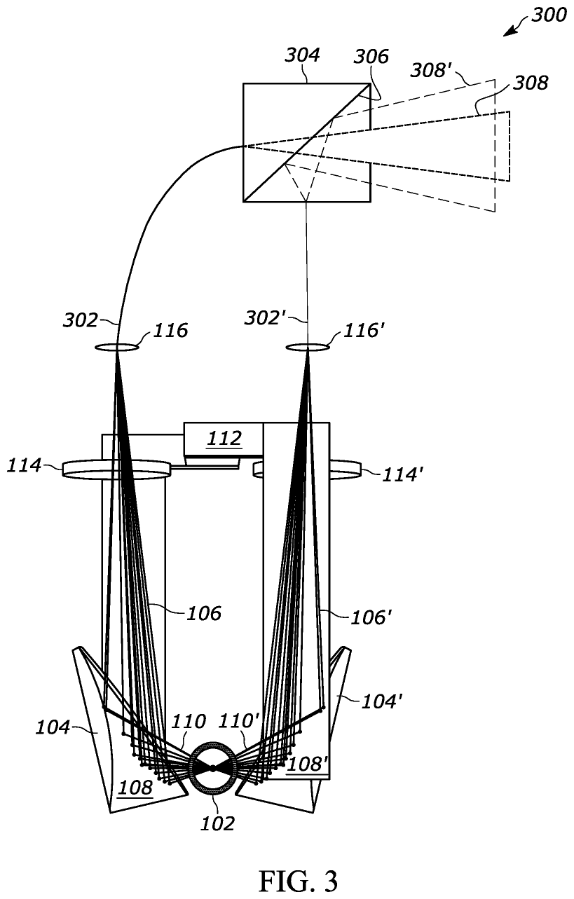

FIG. 3 illustrates a side-view of an embodiment of a dual-output light source optical system 300 configured according to the present teaching that includes a pair of off-axis conical mirrors 104, 104′ that couple flux from the plasma to two separate output channels 106, 106′ that are combined into a single free space optical channel. The dual-output broad-band light source optical system 300 is similar to the dual-output broad-band light source optical system 200 that is described in connection with FIG. 2 but includes a free space optical combiner 304 that generates a combined optical beam that can have different spectral properties. Also, different numerical apertures in the first and second outputs can pass optical beams with different beam profiles.

More specifically, the light source system 300 includes first and second off-axis conical mirrors 104, 104′ that couple light flux from the plasma light source 102 into a first and a second separate optical output channel 106, 106′ as described herein. Like in the previous figures, the dots show ray tracing. The first and second off-axis conical mirrors 104, 104′ include respective reflective surfaces 108, 108′ that are positioned proximate to respective ones of the first and second regions of emission 110, 110′ of the laser-driven light source 102. The surfaces 108, 108′ can include an optical coating that forms an optical filter. The filter function of these optical filters can be, for example, a bandpass filter function or a high or low pass filter function. In many embodiment of the light source of the present teaching, both the surface on the first off-axis conical mirror 104 and the surface on the second off-axis conical mirror 104′ include a coating that forms an optical filter so that the first off-axis conical mirror 104 comprises a filter with a first optical bandwidth and the second off-axis conical mirror 104′ comprises a filter with second optical bandwidth, where the first and second optical bandwidth are not equal.

As described in the previous figures, the first optical filter 114 that passes light with a first optical spectrum is positioned in the first optical path 106. Similarly, the second optical filter 114′ that passes light with a second optical spectrum is positioned in the second optical path 106′. The mechanical frame 112 supports the first and second optical filters 114, 114′.

The first and second optical outputs 116, 116′ are positioned at respective ones of the second focal points of the first and second off-axis conical mirror 104, 104′. In some embodiments, the first optical output 116 is configured with a first numerical aperture and the second optical output 116′ is configured with a second numerical aperture that is different from the first numerical aperture. In the fiber coupled configuration shown in FIG. 3, the first optical output 116 is coupled to a first optical fiber 302 and the second optical output 116′ is coupled to a second optical fiber 302′. The first optical fiber 302 is coupled to a first input of an optical beam combiner 304 and the second optical fiber 302′ is coupled to a second input of the optical beam combiner 304. In one specific embodiment, the optical combiner 304 can comprise a dichroic mirror.

The first optical beam propagating in the first optical fiber 302 from the first output 116 configured with the first numerical aperture is combined with the second optical beam propagating in the second optical fiber 302′ from the second output 116′ configured with the second numerical aperture at the beam splitting interface 306 of the optical combiner 304. FIG. 3 shows a first 308 and second optical beam 308′ with different beam properties that are related to the first and second numerical apertures. In many methods of operating according to the present teaching, the first and second optical beams 308, 308′ having different beam profiles also have different spectral properties.

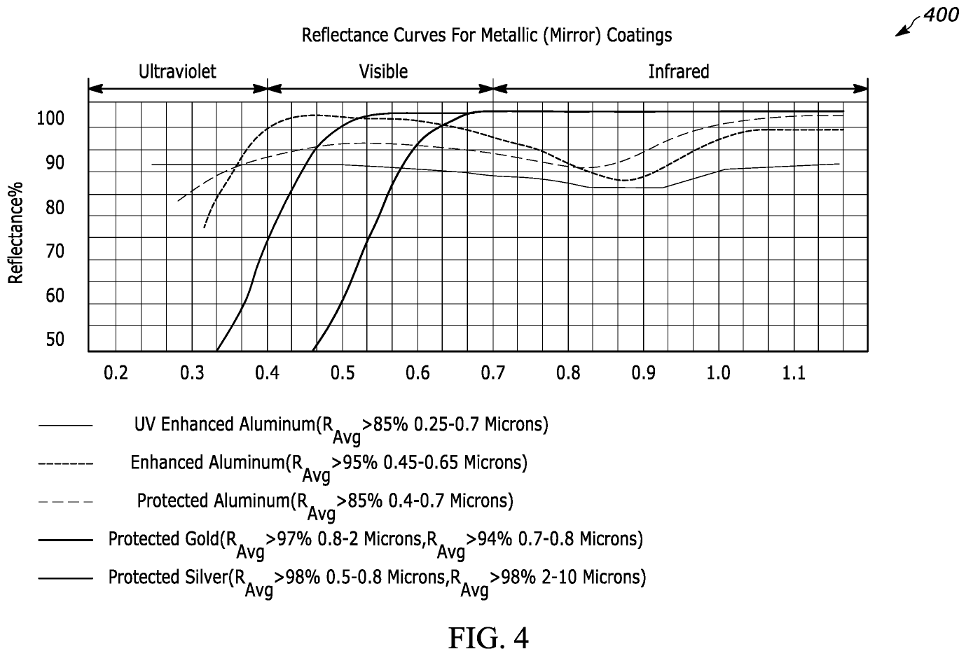

FIG. 4 illustrates data 400 for percentage of reflectance as a function of wavelength in microns for various reflective materials that are suitable for use as a reflective surface for the first and second off-axis conical mirrors 104, 104′ in some embodiments of the dual-output broad-band light source optical system of the present teaching. The use of a particular one of the various reflective material can depend, for example, upon the particular application. Percent reflectance data is presented for infrared to ultraviolet wavelengths for five metallic coatings including UV enhanced aluminum, enhanced aluminum, protected aluminum, protected gold, and protected silver. Embodiments of the dual-output broad-band light source optical system are not limited to the reflective materials described in connection with FIG. 4.

In operation, a method of generating light according to the present teaching includes producing a thermal plasma that generates light over an angular range of emission of at least 180 degrees. The light can be generated over a broad-band optical spectrum. The generated light is propagated to a first focal point of a first off-axis conical mirror where it is reflected in a first optical path. Some methods include moving the first off-axis conical mirror. In some methods, the optical filtering can be performed when reflecting in the first optical path. The light in the first optical path can be filtered to form a first output optical beam with a first optical spectrum. The first optical beam is then propagated to an optical output that is at a second focal point of the first off-axis conical mirror.

Similarly, the generated light is propagated to a first focal point of a second off-axis conical mirror where it is reflected in a second optical path. Some methods include moving the second off-axis conical mirror. The light in the second optical path is filtered to form a second output optical beam with a second optical spectrum. In some methods, the optical filtering can be performed when reflecting in the second optical path. The second optical beam is then propagated to a second optical output that is at a second focal point of the second off-axis conical mirror.

Some methods include coupling at least one of the first and second optical outputs to an optical fiber. Also, some methods include combining the first and second output optical beams into a combined optical beam that propagates in free space or in an optical fiber.

The method of the present teaching can include performing many different types of optical filtering at the first and/or second off-axis conical mirrors and/or in the first and second optical paths so as to produce light with only the desired spectral properties. For example, the optical filtering can be performed so that only ultraviolet light propagates through the first output and only visible light propagates through the second output. Also, the filtering can be performed so that only near-infrared light propagates through the first output and only ultraviolet light propagates through the second output. Also, the filtering can be performed so that only visible light propagates through the first output and only near-infrared light propagates through the second output. In one method, the filtering in the first and second optical paths is substantially the same.

### EQUIVALENTS

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. A dual-output light source comprising:
a) a laser-driven light source that generates light from a thermal plasma over an angular range of emission of at least 180 degrees;
b) a first off-axis conical mirror having a surface with a first coating and being positioned proximate to the thermal plasma so that generated light propagating from a first region of the at least 180-degree angular range of emission strikes a first focal point of the first off-axis conical mirror, the first off-axis conical mirror reflecting light in a first optical path;
c) a second off-axis conical mirror having a surface with a second coating and being positioned proximate to the thermal plasma so that light generated by the laser-driven light source propagating from a second region of the at least 180-degree angular range of emission strikes a first focal point of the surface of the second off-axis conical mirror, the second off-axis conical mirror reflecting light in a second optical path;
d) a first optical filter having a first bandwidth and having an input positioned in the first optical path, wherein the light transmitting through an output of the first optical filter has a first optical spectrum;
e) a first optical output that is positioned at a second focal point of the first off-axis conical mirror in an optical path of light transmitting through the output of the first optical filter;
f) a second optical filter having a second bandwidth and having an input positioned in the second optical path, wherein light transmitting through the output of the second optical filter has a second optical spectrum; and
g) a second optical output that is positioned at a second focal point of the second off-axis conical mirror in an optical path of light transmitting through the output of the second optical filter.

2. The light source of claim 1 wherein at least one of the first and second off-axis conical mirrors comprise an off-axis ellipsoidal mirror.

3. The light source of claim 1 wherein at least one of the first and second off-axis conical mirrors comprise an off-axis-parabolic mirror.

4. The light source of claim 1 wherein the laser-driven light source comprises a broad-band light source that emits ultraviolet light.

5. The light source of claim 1 wherein the laser-driven light source comprises a broad-band light source that emits visible light.

6. The light source of claim 1 wherein the laser-driven light source comprises a broad-band light source that emits near-infrared light.

7. The light source of claim 1 further comprising an optical fiber having an end optically coupled to the first optical output.

8. The light source of claim 1 further comprising a first optical fiber having an end optically coupled to the first optical output and a second optical fiber having an end optically coupled to the second optical output.

9. The light source of claim 1 wherein the first bandwidth comprises a bandwidth in the ultraviolet region of the electromagnetic spectrum and the second bandwidth comprises a bandwidth in the visible region of the electromagnetic spectrum.

10. The light source of claim 1 wherein the first bandwidth comprises a bandwidth in the ultraviolet region of the electromagnetic spectrum and the second bandwidth comprises a bandwidth in the near-infrared region of the electromagnetic spectrum.

11. The light source of claim 1 wherein the first bandwidth comprises a bandwidth in the near-infrared region of the electromagnetic spectrum and the second bandwidth comprises a bandwidth in the visible region of the electromagnetic spectrum.

12. The light source of claim 1 wherein the first and second optical filters are configured with an identical bandwidth.

13. The light source of claim 1 wherein the first optical output is configured with a first numerical aperture and the second optical output is configured with a second numerical aperture that is different from the first numerical aperture.

14. The light source of claim 1 further comprising an optical combiner having a first input that is optically coupled to the first output and a second input that is optically coupled to the second output, an output of the optical combiner providing a combined output optical beam.

15. The light source of claim 14 wherein the optical combiner comprises an optical fiber combiner.

16. The light source of claim 14 wherein the optical combiner comprises a dichroic mirror.

17. The light source of claim 1 wherein the first coating comprises a first filter and the second coating comprises a second filter, wherein a filter function of the first filter is different from a filter function of the second filter.

18. The light source of claim 1 wherein the first coating comprises a first filter and the second coating comprises a second filter, wherein a bandwidth of the first filter is the same as a bandwidth of the second filter.

19. The light source of claim 1 wherein the first coating is the same as the second coating.

20. The light source of claim 1 wherein at least one of the first and the second off-axis conical mirrors include a coating comprising gold.

21. The light source of claim 1 wherein at least one of the first and the second off-axis conical mirrors include a coating comprising aluminum.

22. The light source of claim 1 wherein the first off-axis conical mirror is movable so that a perpendicular to the surface of the first off-axis conical mirror moves relative to the output aperture of the light source.

23. The light source of claim 1 wherein the first off-axis conical mirror is movable so that a perpendicular to the surface of the first off-axis conical mirror moves relative to an output aperture of the light source and the second off-axis conical mirror is movable so that a perpendicular to the surface of the second off-axis conical mirror moves relative to an output aperture of the light source.

24. A method of generating light, the method comprising:
a) producing a thermal plasma that generates light over an angular range of emission of at least 180 degrees;
b) propagating the generated light to a first mirror that reflects the generated light in a first optical path;
c) filtering light in the first optical path to form a first output optical beam with a first optical spectrum;
d) propagating the first output optical beam to a second focal point of the first mirror;
e) propagating the generated light to a second mirror that reflects the generated light in a second optical path;
f) filtering light in the second optical path to form a second output optical beam with a second optical spectrum; and
g) propagating the second output optical beam to a second focal point of the second mirror.

25. The method of claim 24 wherein the propagating the generated light to the first mirror comprises propagating to a focal point of the first mirror.

26. The method of claim 24 further comprising performing optical filtering at the first mirror.

27. The method of claim 24 further comprising performing optical filtering at the first and second mirrors.

28. The method of claim 24 further comprising combining the first and second output optical beams.

29. The method of claim 24 further comprising moving at least one of the first and second mirrors.

30. The method of claim 24 wherein the producing a thermal plasma that generates light comprises generating light with a broad-band light source.

31. The method of claim 24 further comprising coupling at least one of the first output optical beam to an optical fiber.

32. The method of claim 24 further comprising coupling the first output optical beam to an optical device with a first numerical aperture and coupling the second output optical beam to an optical device with a second numerical aperture that is not equal to the first numerical aperture.

33. The method of claim 24 further comprising coupling the first output optical beam to a first input of an optical beam splitter and coupling the second output optical beam to a second input of the optical beam splitter.

34. The method of claim 24 further comprising coupling the first and second output optical beams to a single optical fiber.

35. The method of claim 24 wherein the filtering light in the first optical path to form the first output optical beam with the first optical spectrum comprises filtering to transmit only ultraviolet light and the filtering light in the second optical path to form the second output optical beam with the second optical spectrum comprises filtering to transmit only visible light.

36. The method of claim 24 wherein the filtering light in the first optical path to form the first output optical beam with the first optical spectrum comprises filtering to transmit only ultraviolet light and the filtering light in the second optical path to form the second output optical beam with the second optical spectrum comprises filtering to transmit only near-infrared light.

37. The method of claim 24 wherein the filtering light in the first optical path to form the first output optical beam with the first optical spectrum comprises filtering to transmit only visible light and the filtering light in the second optical path to form the second output optical beam with the second optical spectrum comprises filtering to transmit only near-infrared light.

38. The method of claim 24 wherein the first optical spectrum and the second optical spectrum are identical optical spectrums.

39. The method of claim 24 wherein the first optical spectrum is different from the second optical spectrum.
